(19) United States
(12) Patent Application Publication
(10) Pub. No.: US 2006/0214636 A1
(43) Pub. Date: Sep. 28, 2006

(54) Method and apparatus for equalizing secondary cells

(75) Inventors: Youichi Arai, Shizuoka (JP); Kouichi Yamamoto, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Yazaki Corporation, Tokyo (JP)

(21) Appl. No.: 11/313,656

(22) Filed: Dec. 22, 2005

(30) Foreign Application Priority Data
Mar. 4, 2005 (JP) 2005-060754

(51) Int. Cl. H02J 7/00

(52) U.S. Cl. 320/116; 307/10.1; 320/104

(57) ABSTRACT

The present invention is to provide an equalizing method and an apparatus thereof for preventing unit cells from being over charged and discharged. After an ignition switch is turned off, CPU checks a voltage of a main battery and judges whether the main battery is in a state of equilibrium or not. When the main battery is in the state of equilibrium, the CPU controls a first and second switch groups to equalize voltages of unit cells included in the main battery by repeating a charge transfer from a maximum voltage cell to a minimum voltage cell for a predetermined period of time.

### BACKGROUND OF THE INVENTION

1. Field of the Invention

The present invention relates to an apparatus and a method equalizing a voltage of each unit cell of serially connected secondary cells.

2. Description of the Related Art

Electric and hybrid vehicles utilize electric motors. The electric motors are energized by secondary cells such as nickel-metal hydride cells or lithium cells connecting unit cells in series.

When the serially connected cells are repeatedly charged and discharged, voltages at both ends of the cells show the different values depending on each state of charge (SOC) of the cells, causing that some of the unit cells are overcharged or over discharged. A conventional apparatus for equalizing a capacity of the each unit cell utilizes discharging or capacitors. However, the conventional method does not clearly show the detail of the equalization.

The internal impedances of the cells generate the voltage drops during charging and discharging of the cells and vary with the each unit cell. The equalization of the voltages of the unit cells during the charge and discharge does not provide suitable results on the battery capacity due to large variations of the charge and discharge currents. An apparatus for equalizing the unit cells, which are not during charged or discharged, is proposed in JP-2001-136669-A, JP-2000-312443-A, JP-2002-325370-A.

However, after the charge and discharge of the cells, a polarization remains in the each cell and has a different amount from each other. When the polarization is removed from the cells, the cells each show a different voltage. The equalizing of the voltages of the unit cells having the polarizations causes an overcharge or over discharge to some unit cells. A limit of current sensors for measuring 0 ampere may give a result of 0 ampere even though a very weak current flows.

### SUMMARY OF THE INVENTION

The present invention is to provide a method and an apparatus for equalizing unit cells in order to prevent overcharge or over discharge of the unit cells.

According to a first aspect of the present invention, a method of equalizing a voltage of each unit cell of serially connected secondary unit cells includes the step of equalizing the voltage of the each unit cell when the unit cell is in a state of equilibrium.

Thereby, the voltage of the each unit cell is equalized when the unit cell is in the state of equilibrium, or a polarization is not remained in the unit cell.

According to a second aspect of the present invention, an apparatus for equalizing a voltage of each unit cell of serially connected secondary unit cells includes a CPU being installed; a judging process program in the CPU for judging whether the each unit cell is in a state of equilibrium or not; and an equalizing process program in the CPU for starting equalization of the voltage of the each unit cell when the each unit cell is in the state of equilibrium.

Thereby, the voltage of the each unit cell is equalized when the unit cell is in the state of equilibrium, or a polarization is not remained in the unit cell.

Preferably, the equalizing process program starts the equalization of the voltage of the each unit cell when an ignition switch of a vehicle is turned off and the each unit cell is in the state of equilibrium.

Thereby, there is a enough time to perform the equalization of the unit cells.

Preferably, the judging process program judges that the each unit cell is in the state of equilibrium when a current flow of the unit cell is not detected for a prescribed period of time.

Thereby, it is easily and assuredly judged that the each unit cell is in the state of equilibrium.

Preferably, the judging process program judges that the each unit cell is in the state of equilibrium when the current flow of the unit cell is not detected and the voltage becomes constant.

Thereby, it is easily and assuredly judged that the each unit cell is in the state of equilibrium.

Preferably, the equalizing apparatus further includes a voltage detector for detecting the voltage of the each unit cell, wherein the voltage detector inputs the voltage of the each unit cell to the CPU and the equalizing process program in the CPU repeats a charge transfer operation from a unit cell having the maximum voltage to a unit cell having the minimum voltage through a capacitor for a predetermined period of time.

Thereby, the equalization of the each unit cell is terminated prior to the predetermined period of time when an alternator does not charge to the unit cell or an ignition switch is off. Accordingly, a consumption of a sub-battery supplying electric power for the charge transfer operation is reduced and low SOC thereof is avoided.

Preferably, the predetermined period of time is a time required for the unit cells to reach a constant value in voltage.

Thereby, the charge transfer operation is repeated or terminated depending on the equalization of the unit cells. Accordingly, a consumption of a sub-battery supplying electric power for the charge transfer operation is reduced and low SOC thereof is avoided.

### BRIEF DESCRIPTION OF THE DRAWINGS

FIG. 1 is a circuit showing a first embodiment of an equalizing apparatus of the present invention;

FIG. 2 is a flowchart showing an equalizing process of a CPU installed in the equalizing apparatus of FIG. 1 in the first embodiment; and

FIG. 3 is a flowchart showing an equalizing process of the CPU installed in the equalizing apparatus of FIG. 1 in the second embodiment.

### DETAILED DESCRIPTION OF THE PREFERRED EMBODIMENTS

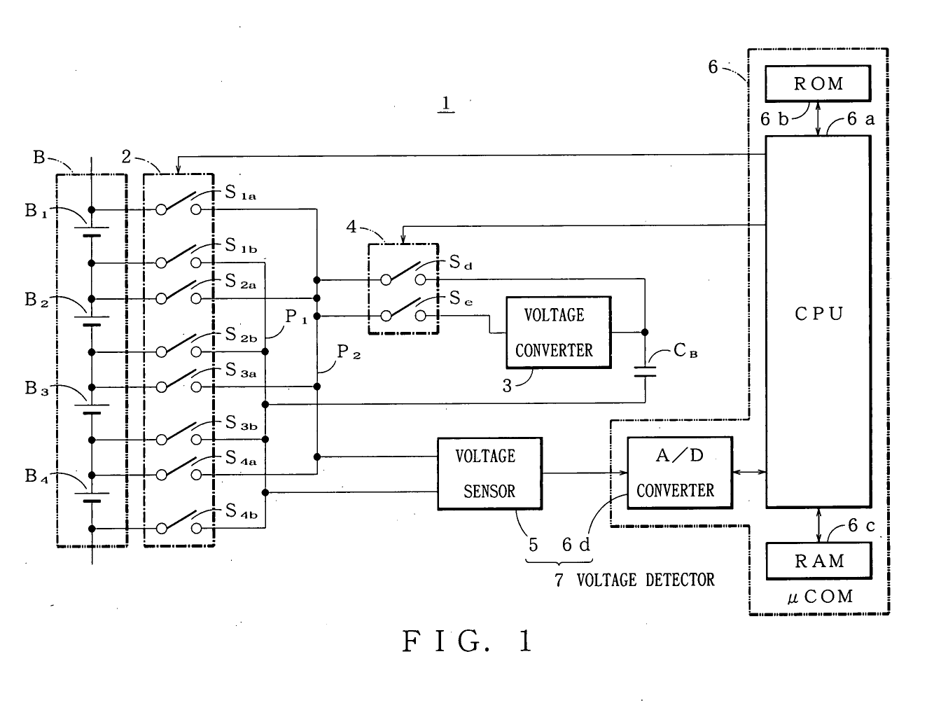

A first embodiment of the present invention is explained by referring to drawings. FIG. 1 is an equalizing apparatus 1 utilizing an equalizing method. The equalizing apparatus 1 of FIG. 1 is utilized for a hybrid electric vehicle driven by an engine and an electric motor (both are not shown). The equalizing apparatus 1 is connected to a main battery B for driving the electric motor.

The main battery B includes serially connected secondary unit cells B1-Bn. The electric motor and an alternator (not shown) for battery charger are connected to both ends of the main battery B.

The equalizing apparatus 1 includes a first switch group 2. Switches S1a-Sna are connected to positive terminals of the unit cells B1-Bn respectively. Switches S1b-Snb are connected to negative terminals of the unit cells B1-Bn respectively. Other ends of the switches of the S1a-Sna and S1b-Snb are connected to each other, respectively.

The equalizing apparatus 1 includes a capacitor C_{B}, a voltage step-up converter 3, and a second switch group 4. They are arranged between a negative line P1 of the switches S1b-Snb and a positive line P2 of the switches S1a-Sna. The voltage converter 4 steps up the voltage of the each unit cell B1-Bn to provide a charge to the capacitor C_{B}.

The second switch group 4 includes switches Sd and Se. The switch Sd connects one end of the capacitor C_{B} with the positive line P2 when it is turned on. The switch Se connects the one end of the capacitor C_{B} with the negative line P1 through the voltage converter 3 when it is turned on.

The equalizing apparatus 1 includes a voltage sensor 5 connected between the lines P1 and P2 and arranged in parallel with the capacitor C_{B}, the voltage converter 3, and the second switch group 4. The voltage sensor 5 outputs an analog voltage signal corresponding to the each voltage of the unit cells B1-Bn connected between the negative line P1 and the positive line P2.

The equalizing apparatus 1 includes a microcomputer (μCOM) 6 connected to terminals of the switch groups 2 and 4. The microcomputer 6 includes a central processing unit (CPU) 6a, a ROM 6b storing programs processed in the CPU 6a, a RAM 6c having a working area for the processing of the CPU 6a and data memory area for storing various data, and an A/D converter 6d for converting the analog voltage signals from the voltage sensor to digital voltage signals and inputting to the CPU 6a. The each device 6b-6d is connected to the CPU 6a with a bus bar. A voltage detector 7 includes the voltage sensor 5 and the A/D converter 6d.

The vehicle has a sub-battery (not shown) besides the main battery B. The sub-battery supplies electric power to electronic parts such as the μCOM 6, voltage sensor 5, and voltage converter 3 utilized for equalizing the main battery B.

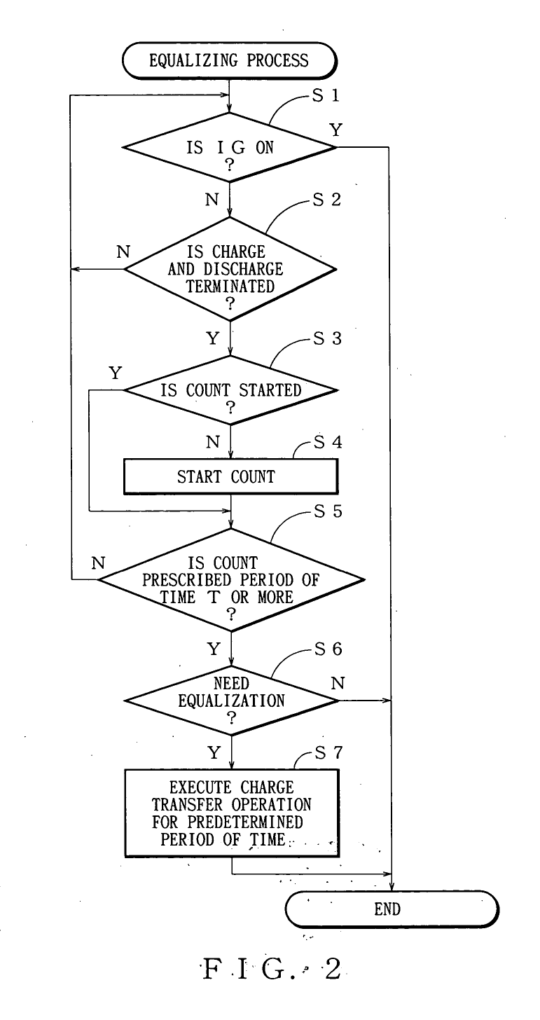

FIG. 2 shows a processing flowchart of an operation of the equalizing apparatus 1 to be processed in CPU 6a. When an ignition switch (IG) of the vehicle is turned off, the CPU 6a initializes the RAM 6c and starts the equalizing process. Then the process moves to a first step S1.

At step S1, the CPU 6a judges that the IG switch is turned on or off. When the IG switch is turned on (Y at step S1), the CPU 6a immediately terminates the equalizing process. If the IG switch is off (N at step S1), the CPU 6a judges at step S2 whether charge and discharge of the main battery B is finished or not. For judging the termination of the charge and discharge, a current sensor (not shown) can be arranged in the equalizing apparatus 1 to detect the charge and discharge current of the main battery B. Output signals from multi-line at the termination of loading operation or at sleep mode are also utilized for judging the termination of the charge and discharge.

When a courtesy lamp or a turbo timer is operated after the IG switch is turned off, the CPU 6a judges that the main battery B is charged and discharged (N at step S2) and repeats steps S1 and S2. When the courtesy lamp or turbo timer is not operated and the charge and discharge of the main battery B is finished (Y at step S2), the CPU 6a judges whether a count of a prescribed period of time T is started or not (step S3). If the count of the prescribed period of the time T is not started (N at step S3), the time count is started (step S4) and step S4 moves to step S5. If the time count T is started (Y at step S3), step S3 directly moves to step S5. The prescribed period of the time T corresponds to a time from the termination of charging and discharging of the main battery B to a sufficient clearance of a residual polarization of the main battery B.

When the IG switch is turned off and the main battery is not charged and discharged for the prescribed period of the time T or more and the time count is finished (Y at step S5) and the each unit cell B1-Bn reaches to a state of equilibrium, the equalizing process moves to step S6. Accordingly, the CPU 6a has a judging process program at step S5.

At step S6, the CPU 6a judges whether it is necessary to equalize the voltages of the all unit cells B1-Bn or not. At step S6, the CPU 6a detects the each voltage of the all unit cells B1-Bn. This is done by connecting the switches S1a/S1b, S2a/S2b, . . . , Sna/Snb of the unit cells B1, B2, . . . , Bn, respectively to the voltage sensor 5 sequentially.

The voltage sensor 5 measures the voltage of the each unit cell B1-Bn and inputs the analog value to the A/D converter 6d synchronized with the second switch group 4 being turned on or off. Then, the digital voltage signals are provided to the CPU 6a.

Based on the voltage input by the voltage detector, the CPU 6a selects a cell Bmax having the maximum voltage and a cell Bmin having the minimum voltage among the unit cells B1-Bn and compares the voltage difference between the cells Bmax, Bmin with a prescribed threshold value. When the voltage difference is higher than the threshold value, the CPU 6a decides the equalization to be necessary.

When the difference is smaller than the threshold value, the CPU 6a decides the equalization to be unnecessary (N at step S6) and the equalization is finished.

When the CPU 6a decides the equalization to be necessary (Y at step S6), the CPU 6a starts an equalizing process program to carry out a charge transfer operation for a predetermined period of time (step S7). At step S7, the CPU 6a turns on the switches Smaxa and Smaxb of the maximum voltage cell Bmax, and Se to connect the both terminals of the Bmax to the capacitor C_{B} through the voltage converter 3.

At this connection, the voltage converter 3 increases the voltage of the unit cell Bmax. Accordingly, the charge transfers from the Bmax to the capacitor C_{B} through the converter 3 and charges the capacitor C_{B} to a maximum operation voltage.

When the charge transfer is finished, the CPU 6a turns off the switches Smaxa, Smaxb, Se. The CPU 6a next turns on the switches Smina and Sminb of the minimum voltage cell Bmin, and Sd. In this case, the both terminals of the cell Bmin are connected to the capacitor C_{B} without through the voltage converter 3. At this connection, a charge corresponding to the voltage difference between the capacitor C_{B} and the cell Bmin is transferred to the unit cell Bmin from the capacitor C_{B}.

When the charge transfer is finished, the CPU 6a turns off Smina, Sminb, and Sd. After that, the CPU 6a again selects the Bmax and Bmin based on the voltage detector 7 and repeats the charge transfer operation for the predetermined period of time (step S7) and finishes the equalizing process. From the above operations, the CPU 6a equalizes the unit cells B1-Bn after transferring the charge with the predetermined time from the maximum voltage unit cell Bmax to the minimum voltage unit cell Bmin through the capacitor C_{B}.

According to the equalizing apparatus 1 described above, the equalizing operation is performed when the plurality of the unit cells B1-Bn are not charged and discharged for the prescribed period of time T at steps S2-S4 and are in the state of equilibrium. The unit cells B1-Bn are equalized when they are in the state of equilibrium and do not have the polarizations. After the equalization of the both terminals of the unit cells B1-Bn, the polarizations are cleared and the variations of the voltages of the unit cells B1-Bn are removed so that the overcharge and over discharge of the unit cells B1-Bn are prevented.

When the IG switch is on, the unit cells B1-Bn are frequently charged and discharged so that they are hardly in the states of equilibrium and are not equalized. When the IG switch is off, the unit cells B1-Bn are hardly charged and discharged and the states of equilibrium of the unit cells B1-Bn are retained for enough times to be equalized.

According to the equalizing apparatus 1, the charge transfer operation is repeated for the predetermined period of time and the equalization is finished. Then, when the IG switch is off or the alternator does not charge, the equalization is not performed after the predetermined period of time. The consumption of the sub-battery providing the power for the charge transfer operation is reduced and the low SOC thereof is avoided.

In the first embodiment, the count of the predetermined period of time T is started after the IG switch is turned off and the charge and discharge of the main battery B are finished. However, when the main battery B is not charged and discharged after the IG switch is turned off, the count of the predetermined period of time T can be immediately started after the IG switch is turned off.

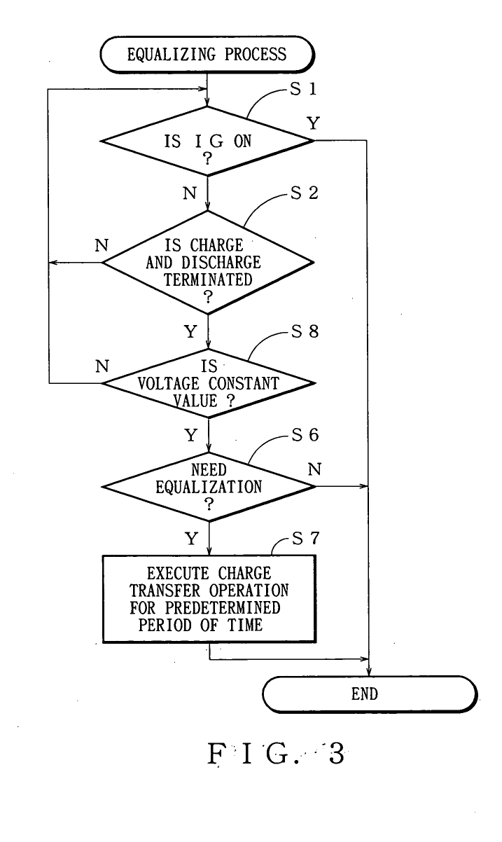

A second embodiment of the present invention is explained. An equalizing apparatus of the second embodiment is same as that of the first embodiment (FIG. 1). An operation of the equalizing apparatus 1 of the second embodiment is explained by referring to a flowchart of FIG. 3 showing a equalizing process by the CPU 6a. Same steps of FIG. 2 and FIG. 3 have the same reference signs. The detail explanation is omitted.

When the IG switch of the vehicle is turned off, the CPU 6a initializes the RAM 6c in the μCOM 6 and starts the equalizing process. The process moves to step S1. At step S1, the CPU 6a judges that the IG switch is on or off. When the IG switch is on (Y at step S1), the CPU 6a immediately terminates the equalizing process. If the IG switch is off (N at step S1), the CPU 6a judges at step S2 whether the charge and discharge of the main battery B is finished or not.

If the charge and discharge of the main battery B is not finished (N at step S2), the CPU 6a returns to step S1. When the charge and discharge of the main battery B is finished (Y at step S2), the CPU 6a moves to step S8 to judge whether the positive and negative terminals of the main battery B have a constant voltage value. More specifically, the voltage of the main battery B is successively measured three times every 15 minutes. When the measured voltages are same within an accuracy of the voltmeter, the voltage of the main battery is assumed to be constant.

After the polarization of the main battery B is cleared and the voltage becomes constant (Y at step S8), the CPU 6a moves step S6 and S7 to equalize the battery when necessary.

When the each voltage of the unit cells B1-Bn attains the constant value after clearing the polarization, it is judged that the states of equilibrium are reached.

In the second embodiment, the voltage of the main battery B is measured whether the voltage is constant or not after the IG switch is OFF and the charge and discharge of the battery is finished. However, when the main battery B is charged and discharged and is not in the state of equilibrium, the voltage of the main battery B can not be constant so that the voltage measurement can be made right after the IG switch is turned off to judge the voltage being constant or not.

In the first and second embodiments, the charge transfer operation is repeated for the predetermined period of time at step S7. A charge transfer operation time, which is a time required for the voltage variation among the unit cells B1-Bn to be removed, may be measured. Then, the charge transfer operation can be repeated only with the charge transfer operation time. This prevents the charge transfer operation from being repeated when the alternator does not charge or the IG switch is off and the variation of the voltages of the unit cells B1-Bn is removed. The capacity consumption of the sub-battery providing the power for the charge transfer operation is reduced and the low SOC thereof is avoided. This prevents the charge transfer operation from terminating prior to the voltage variation is cleared.

The first and second embodiments disclose the equalizing apparatus 1 for equalizing the unit cells B1-Bn included in the main battery B. However, the apparatus is also adapted to unit cells included in the sub-battery.

1. A method of equalizing a voltage of each unit cell of serially connected secondary unit cells, comprising:
the step of equalizing the voltage of the each unit cell when the unit cell is in a state of equilibrium.

2. An apparatus for equalizing a voltage of each unit cell of serially connected secondary unit cells, comprising:
a CPU being installed;
a judging process program processed in the CPU for judging whether the each unit cell is in a state of equilibrium or not; and
an equalizing process program processed in the CPU for starting equalization of the voltage of the each unit cell when the each unit cell is in the state of equilibrium.

3. The apparatus as claimed in claim 2, wherein said equalizing process program starts the equalization of the voltage of the each unit cell when an ignition switch of a vehicle is turned off and the each unit cell is in the state of equilibrium.

4. The apparatus as claimed in claim 2, wherein said judging process program judges that the each unit cell is in the state of equilibrium when a current flow of the unit cell is not detected for a prescribed period of time.

5. The apparatus as claimed in claim 2, wherein said judging process program judges that the each unit cell is in the state of equilibrium when the current flow of the unit cell is not detected and the voltage becomes constant.

6. The apparatus as claimed in claim 3, further comprising a voltage detector for detecting the voltage of the each unit cell, wherein said voltage detector inputs the voltage of the each unit cell to the CPU and the equalizing process program in the CPU repeats a charge transfer operation from a unit cell having the maximum voltage to a unit cell having the minimum voltage through a capacitor for a predetermined period of time.

7. The apparatus as claimed in claim 6, wherein said predetermined period of time is a time required for the unit cells to reach a constant value in voltage.
